(19) United States
(12) Patent Application Publication
(10) Pub. No.: US 2021/0349479 A1
(43) Pub. Date: Nov. 11, 2021

(54) FOLLOWING MOBILE PLATFORM AND METHOD THEREOF

(71) Applicant: TECO Electric & Machinery Co., Ltd., Taipei City (TW)

(72) Inventors: Chia Jen LIN, Taipei City (TW); Po-Huang SU, Taipei City (TW); Shih-Chang CHEU, Taipei City (TW); Chun Chi LAI, Taipei City (TW)

(21) Appl. No.: 16/918,280

(22) Filed: Jul. 1, 2020

(30) Foreign Application Priority Data
May 6, 2020 (TW) 109114976

(51) Int. Cl. G05D 1/12; G05D 1/02

(52) U.S. Cl. CPC G05D 1/12; G05D 1/0212

(57) ABSTRACT

A following mobile platform includes a scanning module, a judging module, a following command generation module and a controlling module. The scanning module, having a scanning area with a target-locked area, is used for generating first and second scan information by scanning the target-locked area and the scanning area, respectively. The judging module is used for judging the first and second scan information and for defining a user to be the followed target upon when the user facing or facing away from the following mobile platform is determined to be within the target-locked area. The following command generation module is used for generating a following command to follow the followed target moving within the scanning area. The controlling module is used for evaluating the following command to generate a control signal for controlling the following mobile platform to move with the followed target according to the following command.

This application claims the benefit of Taiwan Patent Application Serial No. 109114976, filed May 6, 2020, the subject matter of which is incorporated herein by reference.

### BACKGROUND OF THE INVENTION

### (1) Field of the Invention

The invention relates to a mobile platform and a method of the mobile platform, and more particularly to a following mobile platform and a method for following the mobile platform.

### (2) Description of the Prior Art

With the advancement of technology, robots have been widely applied to various industries and fields, such as restaurants, banks, restaurants, factories, warehouses, etc. Operations of the conventional robots are usually relied on manual instructions to perform corresponding actions. However, if convenience to enter instructions is not easy while in patrolling or moving in the factory or warehouse, effectiveness of the manual-operated robot would be limited. Thus, the conventional robot do have room for improvement.

### SUMMARY OF THE INVENTION

In view that the effectiveness of conventional robots would be limited upon when inputting instructions is not so easy, accordingly it is an object of the present invention to provide a following mobile platform that can resolve at least one of the aforesaid shortcomings in the art.

In the present invention, the following mobile platform, applied to follow a followed target, includes a scanning module, a judging module, a following command generation module and a controlling module.

The scanning module, having a scanning area and a target-locked area within the scanning area, is used for scanning and thus generating first scan information and second scan information by scanning the target-locked area and the scanning area, respectively. The judging module, electrically connected with the scanning module, is used for receiving and judging the first scan information and the second scan information and for defining a user to be the followed target upon when the user is determined to be within the target-locked area by facing or facing away from the following mobile platform. The following command generation module, electrically connected with the judging module, is used for generating a following command to follow the followed target moving within the scanning area. The controlling module, electrically connected with the following command generation module, is used for evaluating the following command to generate a control signal for controlling the following mobile platform to move with the followed target according to the following command.

In one embodiment of the present invention, the judging module further includes a time unit for calculating a preset time, and the judging module relieves the user from the followed target upon when the user is determined not to be in the scanning area within the preset time.

In one embodiment of the present invention, the judging module includes a calf-shape judging unit for confirming the user facing or facing away from the following mobile platform to be within the target-locked area upon when the calf-shape judging unit judges that the first scan information includes two quasi-semicircular arcs adjacent to each other and with the same shape and intensity.

In one embodiment of the present invention, the judging module further includes a target-center judging unit electrically connected with the calf-shape judging unit and used for evaluating the two quasi-semicircular arcs to determine a target center point for standing for a target position of the followed target.

In one embodiment of the present invention, the following command generation module includes a platform-center positioning unit and a route-command generating unit. The platform-center positioning unit is used for locating a platform center point of the following mobile platform. The route-command generating unit, electrically connected with the platform-center positioning unit and the target-center judging unit, is used for applying the target center point and the platform center point to generate the following command

In one embodiment of the present invention, the following command generation module further includes a distance judging unit electrically connected with the target-center judging unit, the platform-center positioning unit and the route-command generating unit and used for applying the platform center point and the target center point to calculate a distance between the following mobile platform and the followed target, and the route-command generating unit is applied to generate the following command upon when the distance is greater than a preset distance.

In one embodiment of the present invention, the scanning module further includes a scanning-area adjusting unit for adjusting the scanning area.

It is another object of the present invention is to provide a method for following a mobile object, applied to the aforesaid following mobile platform, includes the steps of: (a) applying the scanning module to scan and generate the first scan information and the second scan information; (b) applying the judging module to determine the first scan information and the second scan information, and defining the user to be the followed target upon when the user facing or facing away from the following mobile platform is within the target-locked area; (c) applying the following command generation module to generate the following command for following the followed target upon when the followed target moves within the scanning area; and (d) applying the controlling module to evaluate the following command to generate the control signal for controlling the following mobile platform to move with the followed target according to the following command.

In one embodiment of the present invention, the scanning module further includes a calf-shape judging unit, and the step (b) further includes a step of (b1) applying the calf-shape judging unit to confirm that the user facing or facing away from the following mobile platform is within the target-locked area upon when the first scan information includes two quasi-semicircular arcs adjacent to each other and with the same shape and intensity.

In one embodiment of the present invention, the method for following a mobile object further includes a step of (e) applying a time unit of the judging module to calculate a preset time, and relieving the user from the followed target upon when the judging module determines that the user is not within the scanning area for the preset time.

As stated above, the following mobile platform and the method thereof provided by this invention apply the scanning module and the judging module to define a user to be a followed target upon when the user facing or facing away from the following mobile platform is determined to be within the target-located area, and further apply the following command generation module and the controlling module to control the following mobile platform to move with the followed target. In comparison with the conventional design, this invention can automatically follow the followed target without manual-inputted commands. Thus, the practicality and effectiveness can be enhanced.

All these objects are achieved by the following mobile platform and the method thereof described below.

### BRIEF DESCRIPTION OF THE DRAWINGS

The present invention will now be specified with reference to its preferred embodiment illustrated in the drawings, in which:

FIG. 1 is a schematic block view of a preferred embodiment of the following mobile platform in accordance with the present invention;

FIG. 2 is a schematic perspective view of the following mobile platform of FIG. 1;

FIG. 3 is a schematic view of a scanning area and a target-locked area for the following mobile platform of FIG. 1;

FIG. 4 demonstrates schematically that the following mobile platform of FIG. 1 is performing a scan;

FIG. 5 shows schematically the first scan information of FIG. 4;

FIG. 6 demonstrates schematically that the following mobile platform of FIG. 1 is performing another scan;

FIG. 7 shows schematically the first scan information of FIG. 6;

FIG. 8 demonstrates schematically that the following mobile platform of FIG. 1 judges a target center point;

FIG. 9 shows schematically a move of the target center point of FIG. 8;

FIG. 10 demonstrates schematically that the following mobile platform of FIG. 1 follows the target center point; and

FIG. 11 is a flowchart of a preferred embodiment of the method for following a mobile object in accordance with the present invention.

### DESCRIPTION OF THE PREFERRED EMBODIMENT

The invention disclosed herein is directed to a following mobile platform and a method thereof. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

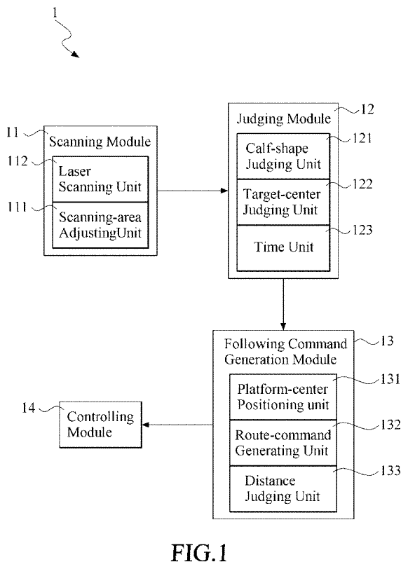

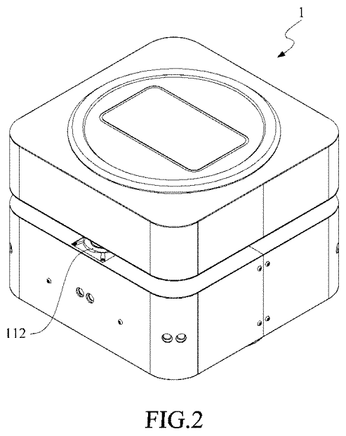

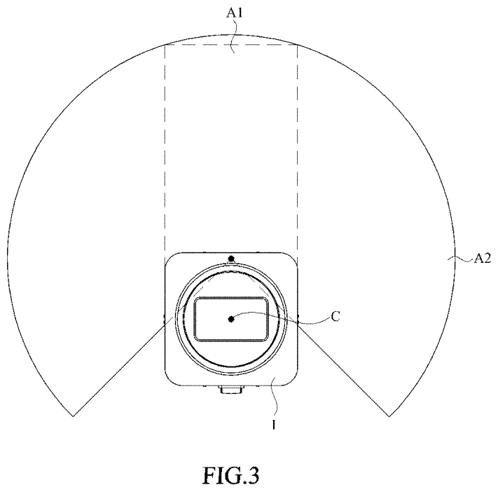

Refer now to FIG. 1 to FIG. 3; where FIG. 1 is a schematic block view of a preferred embodiment of the following mobile platform in accordance with the present invention, FIG. 2 is a schematic perspective view of the following mobile platform of FIG. 1, and FIG. 3 is a schematic view of a scanning area and a target-locked area for the following mobile platform of FIG. 1. As shown, the following mobile platform 1 includes a scanning module 11, a judging module 12, a following command generation module 13 and a controlling module 14.

The scanning module 11, having a target-locked area A1 and a scanning area A2, is used for scanning and obtaining first scan information and second scan information with respect to the target-locked area A1 and the scanning area A2, respectively, in which the target-locked area A1 is located within the scanning area A2. In this embodiment, the scanning module 11 includes a scanning-area adjusting unit 111 and a laser scanning unit 112. The scanning-area adjusting unit 111 is used for adjusting a size of the scanning area A2.

The judging module 12, electrically connected with the scanning module 11, is used for receiving and evaluating the first scan information and the second scan information. In the case that a user facing or facing away from the following mobile platform 1 is determined to exist within the target-locked area A1, this user is defined as a target to be followed (thereafter, a followed target). In this embodiment, the judging module 12 includes a calf-shape judging unit 121, a target-center judging unit 122 and a time unit 123.

The following command generation module 13, electrically connected with the judging module 12, is used for generating a following command accompanying the followed target as the followed target is moving within the scanning area A2. In this embodiment, the following command generation module 13 includes a platform-center positioning unit 131, a route-command generating unit 132 and a distance judging unit 133.

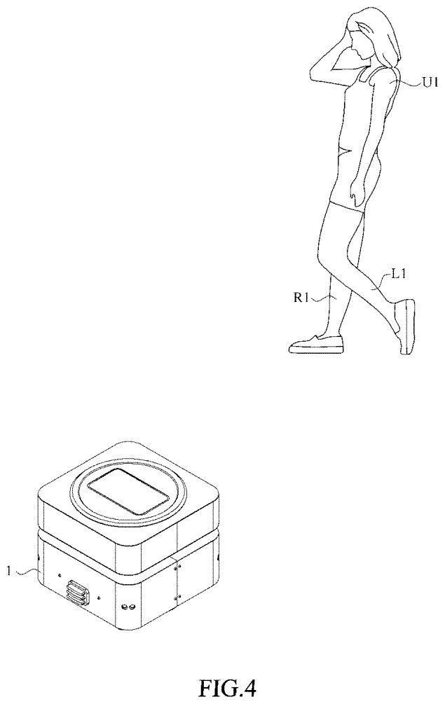

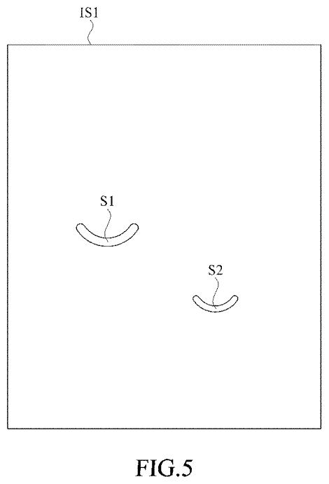

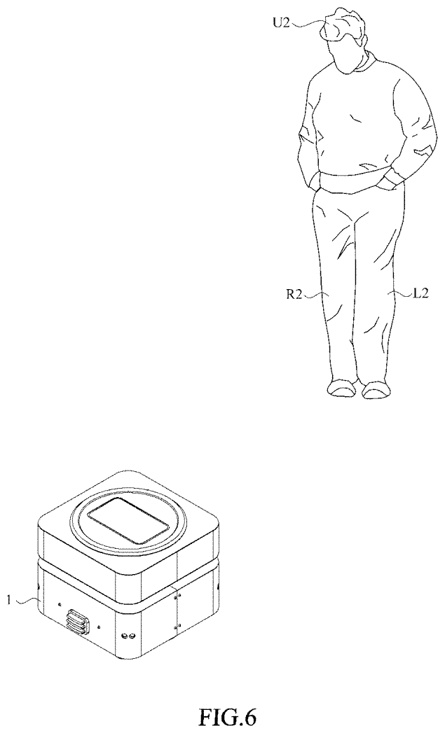

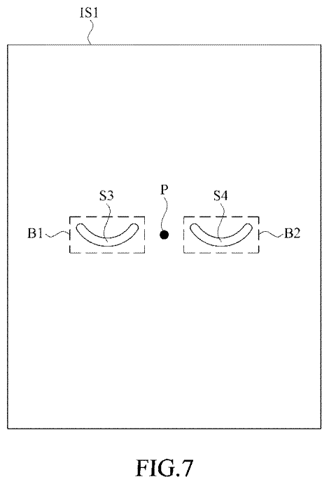

Then, refer together from FIG. 1 to FIG. 7; where FIG. 4 demonstrates schematically that the following mobile platform of FIG. 1 is performing a scan, FIG. 5 shows schematically the first scan information of FIG. 4, FIG. 6 demonstrates schematically that the following mobile platform of FIG. 1 is performing another scan, and FIG. 7 shows schematically the first scan information of FIG. 6.

In FIG. 4, a user U1 is within the target-locked area A1 with one her lateral side close to the following mobile platform 1, not by directly facing or facing away from the following mobile platform 1. In this situation, the scanning module 11 would scan the target-locked area A1 and generate the corresponding first scan information IS1, as shown in FIG. 5. In FIG. 5, the first scan information IS1 includes two quasi-semicircular arcs S1, S2, separated from each other and with different shapes. Thus, the calf-shape judging unit 121 would determine that the user U1 within the target-locked area A1 does not face or face away directly from the following mobile platform 1, and therefore the judging module 12 will not define the user U1 as a followed target.

Further, practically, the scanning module 11 is arranged to focus at user's calf. Thus, the quasi-semicircular arc S1 of the first scan information IS1 is practically corresponding to a right calf R1 of the user U1, while the quasi-semicircular arc S2 of the first scan information IS1 is corresponding to a left calf L1 of the user U1. Since the user U1 stands with her left calf L1 close to the following mobile platform 1, thus the quasi-semicircular arc S2 of the first scan information IS1 would be closer to the following mobile platform 1, in comparison with the quasi-semicircular arc S1. Further, for the user U1 has her left leg to tip the ground, so a scan point at the left calf L1 by the scanning module 11 would be lower than that at the right calf R1. Namely, the scanning module 11 is much closer to the left ankle, and thus the quasi-semicircular arc S2 of the first scan information IS1 would be smaller than the quasi-semicircular arc S1 thereof.

In addition, since a distance between the right calf R1 and the scanning module 11 is different to that between the left calf L1 and the scanning module 11, thus the respective scan positions would be different, and intensities of the quasi-semicircular arc S1 and the quasi-semicircular arc S2 in the first scan information IS1 are different as well.

Referring now to FIG. 6, another user U2 within the target-locked area A1 exists to directly face the following mobile platform 1. Thus, the scanning module 11 would scan and produce corresponding first scan information IS1, as shown in FIG. 7. In FIG. 7, the first scan information IS1 includes two quasi-semicircular arcs S3, S4 corresponding to a right calf R2 and a left calf L2 of the user U2, respectively.

For the calf-shape judging unit 121 would judge that the two quasi-semicircular arcs S3, S4 are adjacent to each other and with the same intensity, thus the user U2 of the target-locked area A1 can be determined to face the following mobile platform 1. At this time, the judging module 12 would further define the user U2 as one followed target.

The target-center judging unit 122 would evaluate the quasi-semicircular arcs S3, S4 to decide a target center point P of the user U2, and define the target center point P to be a target position of this followed target; i.e., an instant position of the user U2. Preferably, the target-center judging unit 122 would firstly utilize the quasi-semicircular arcs S3, S4 to define block areas B1, B2, respectively. Then, in this embodiment, the target-center judging unit 122 would define a center point between the two block areas B1, B2 to be the target center point P. However, in another embodiment, the target-center judging unit 122 can utilize curvatures of the quasi-semicircular arcs S3, S4 to calculate corresponding arc centers, and then the target center point P can be defined by a middle point of the two arc centers.

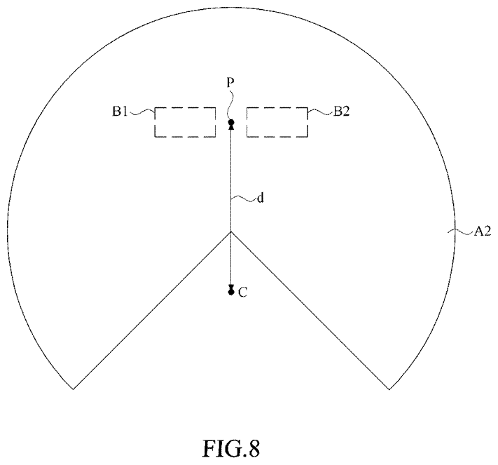

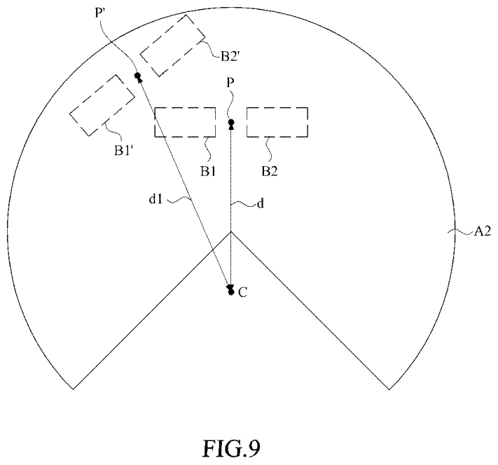

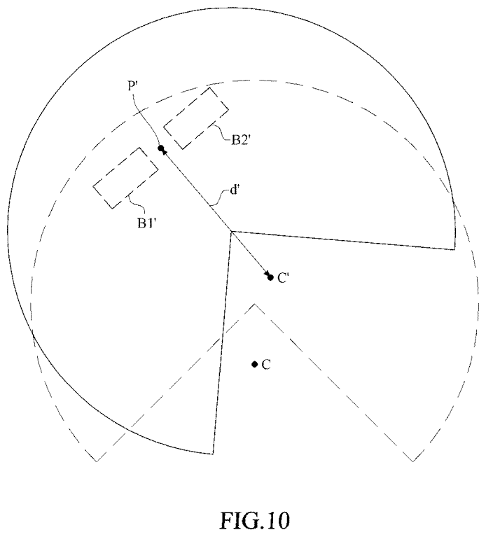

Then, refer now from FIG. 1 to FIG. 10; where FIG. 8 demonstrates schematically that the following mobile platform of FIG. 1 judges a target center point, FIG. 9 shows schematically a move of the target center point of FIG. 8, and FIG. 10 demonstrates schematically that the following mobile platform of FIG. 1 follows the target center point. As shown, the target center point P is located within the scanning area A2. Namely, the user U2 defined as the followed target is now within the scanning area A2.

The platform-center positioning unit 131 would locate a platform center point C for the following mobile platform 1. The route-command generating unit 132, electrically connected with the platform-center positioning unit 131 and the target-center judging unit 122, is used for applying the target center point P and the platform center point C to generate corresponding following commands.

Preferably, the distance judging unit 133, electrically connected with the target-center judging unit 122, the platform-center positioning unit 131 and the route-command generating unit 132, is used for calculating a distance d between the target center point P and the platform center point C, and for applying the route-command generating unit 132 to generate following commands upon when the distance d is greater than a preset distance.

Practically, the distance judging unit 133 would generally define the distance between the user U2 and the following mobile platform 1 to be the preset distance. For example, while the user U2 faces the following mobile platform 1 with 1-m spacing from the following mobile platform 1, and after the user U2 is defined as the followed target, the distance judging unit 133 would set the preset distance to be 1 meter. Thus, when the user U2 begins to move away from the following mobile platform 1 by a distance greater than 1 meter, the route-command generating unit 132 would generate a following command to order the following mobile platform 1 to move immediately with the user U2. Nevertheless, in some other embodiments, the preset distance can be set to be greater or less than 1 meter.

In this embodiment, the distance judging unit 133 would set the distance d to be the preset distance. As shown in FIG. 9, when the target center point P moves to the target center point P′ (i.e., when the user U2 defined as the followed target moves within the scanning area A2), as the distance judging unit 133 judges that a distance d1 between the target center point P′ and the platform center point C is greater than the distance d (i.e., the preset distance), the route-command generating unit 132 would be applied to generate a corresponding following command. Then, the controlling module 14 would evaluate the following command to generate a control signal for controlling the following mobile platform 1 to move with the followed target (i.e., the user U2). In addition, since the user U2 defined as the followed target moves within the scanning area A2, thus the block area B1 related to the right calf R2 of the user U2 and the block area B2 related to the left calf L2 of the user U2 would move with the block area B1′ and the block area B2′, respectively.

In this embodiment, as the platform center point C moves to the platform center point C′, it implies that the following mobile platform 1 standing for the platform center point moves with the followed target and is spaced from the target center point P′ by a distance d′. Preferably, the platform center point C′ would move in front of or behind the followed target by spacing the distance d′ with the target center point P′, as shown in FIG. 10. In some other embodiments, the platform center point C can directly move in a direction, for example, parallel to the distance d1 of FIG. 9, and then stop at a place that is spaced from the target center point P′ by a distance equal to the distance d, so as to follow the followed target.

Thus, the following mobile platform 1 can move with the followed target so as to enhance practicality and effectiveness. When a user needs to work in a warehouse, a factory, a cafeteria or the like, the user can move into the target-locked area A1 of the following mobile platform 1 by facing or facing away from the following mobile platform 1, and thus the user can be defined as the followed target of following mobile platform 1. Then, the following mobile platform 1 would begin to follow the user to move.

The time unit 123 would calculate a preset time. Then, if the judging module 12 determines that, within the preset time, the user U2 is not in the scanning area A2, the user U2 would be relieved from the followed target. For example, for the preset time to be a minute, when the user U2 (already defined as the followed target in a previous time) leaves the scanning area A2 for any reason, if the judging module 12 cannot confirm within a minute that the user U2 having the identity of the followed target is within the scanning area A2, then the identity as the followed target will be relieved from the user U2. In other words, if the user U2 does appear in the scanning area A2 two minutes later, the following mobile platform 1 would be no more to follow the user U2, because at this time the user U2 has been relieved from the identity of the followed target. However, if it is hoped to have the following mobile platform 1 to follow the user again, the user needs to re-enter the target-locked area A1 and to face or face away from the following mobile platform 1.

If the followed target needs to move frequently within the scanning area A2, then the scanning-area adjusting unit 111 can be applied to enlarge the scanning area A2 so as to prevent the identity of the followed target from been terminated by the judging module 12. On the other hand, if the followed target needn't to move frequently within the scanning area A2, then the scanning-area adjusting unit 111 can be also applied to reduce the scanning area A2, so that the following mobile platform 1 can always follow the followed target.

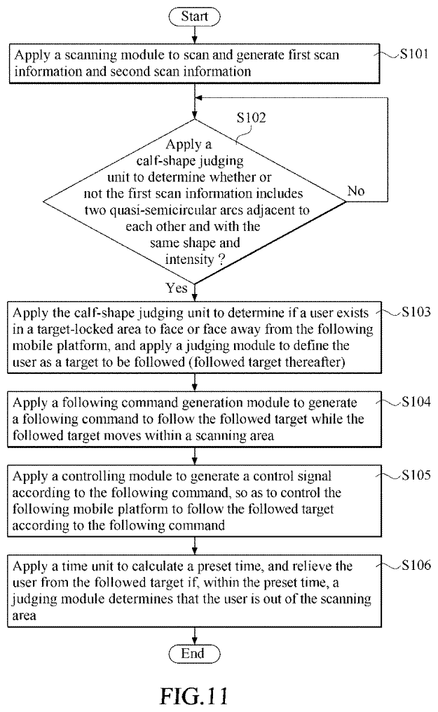

Finally, referring now to FIG. 11, a flowchart of a preferred embodiment of the method for following a mobile object in accordance with the present invention is shown. The method for following a mobile object, applied preferably to the following mobile platform 1 of FIG. 1, includes Step S101 to Step S106 as follows.

Step S101: Apply a scanning module to scan and thus generate first scan information and second scan information.

In Step S101, the scanning module 11 of FIG. 1 is applied to scan the target-locked area A1 of FIG. 3 to generate the first scan information and the scanning area A2 of the FIG. 3 to generate the second scan information.

Step S102: Apply a calf-shape judging unit to determine whether or not the first scan information includes two quasi-semicircular arcs adjacent to each other and with the same shape and intensity.

In Step S102, the calf-shape judging unit 121 of the judging module 12 of FIG. 1 is applied to determine whether or not two quasi-semicircular arcs adjacent to each other and with the same shape and intensity, as shown in FIG. 7, exist in the first scan information IS1. If the determination of Step S102 is positive, then go to Step S103.

Step S103: Apply the calf-shape judging unit to determine if a user exists in a target-locked area to face or face away from the following mobile platform, and apply a judging module to define the user as a target to be followed (followed target thereafter).

In Step S103, the judging module 12 of FIG. 1 is applied to define the user to be the followed target, as shown in FIG. 6 and FIG. 7.

With Steps S102 and S103, the judging module is applied to determine the first scan information and the second scan information. In the case that the user is judged to be within the target-locked area by facing or facing away from the following mobile platform, the user is then defined as the followed target. In this embodiment, the calf-shape judging unit of the judging performs this determination.

Step S104: Apply a following command generation module to generate a following command to follow the followed target while the followed target moves within the scanning area.

In Step S104, the route-command generating unit 132 of FIG. 1 is applied to generate the following command.

Step S105: Apply a controlling module to generate a control signal according to the following command, so as to control the following mobile platform to follow the followed target according to the following command

In Step S105, based on the following command, the controlling module 14 of FIG. 1 generates the control signal and further controls the following mobile platform 1 to move with the followed target, as shown in FIG. 8 to FIG. 10.

Step S106: Apply a time unit to calculate a preset time, and relieve the user from the followed target if, within the preset time, a judging module determines that the user is out of the scanning area.

In Step S106, the time unit 123 of FIG. 1 is used to calculate the preset time, and the identity of the followed target for the user is terminated if the judging module cannot determine that the user exists in the scanning area within the preset time, as previously described.

As described above, the following mobile platform and the method thereof provided by this invention apply the scanning module and the judging module to define a user to be a followed target upon when the user facing or facing away from the following mobile platform is determined to be within the target-located area, and further apply the following command generation module and the controlling module to control the following mobile platform to move with the followed target. In comparison with the conventional design, this invention can automatically follow the followed target without manual-inputted commands. Thus, the practicality and effectiveness can be enhanced. In addition, this invention can also prevent the following mobile platform from following a wrong user if more than one user exists in the scanning area. Further, the present invention can terminate the identity of the followed target from the user who is judged not to be within the scanning area for a preset time.

While the present invention has been particularly shown and described with reference to a preferred embodiment, it will be understood by those skilled in the art that various changes in form and detail may be without departing from the spirit and scope of the present invention.

What is claim is:

1. A following mobile platform, applied to follow a followed target, comprising:
a scanning module, having a scanning area and a target-locked area within the scanning area, used for generating first scan information and second scan information by scanning the target-locked area and the scanning area, respectively;
a judging module, electrically connected with the scanning module, used for receiving and judging the first scan information and the second scan information and for defining a user to be the followed target upon when the user is determined to be within the target-locked area by facing or facing away from the following mobile platform;
a following command generation module, electrically connected with the judging module, used for generating a following command to follow the followed target moving within the scanning area; and
a controlling module, electrically connected with the following command generation module, used for evaluating the following command to generate a control signal for controlling the following mobile platform to move with the followed target according to the following command.

2. The following mobile platform of claim 1, wherein the judging module further includes a time unit for calculating a preset time, and the judging module relieves the user from the followed target upon when the user is determined not to be in the scanning area within the preset time.

3. The following mobile platform of claim 1, wherein the judging module includes a calf-shape judging unit for confirming the user facing or facing away from the following mobile platform to be within the target-locked area upon when the calf-shape judging unit judges that the first scan information includes two quasi-semicircular arcs adjacent to each other and with the same shape and intensity.

4. The following mobile platform of claim 3, wherein the judging module further includes a target-center judging unit electrically connected with the calf-shape judging unit and used for evaluating the two quasi-semicircular arcs to determine a target center point for standing for a target position of the followed target.

5. The following mobile platform of claim 4, wherein the following command generation module includes:
a platform-center positioning unit, used for locating a platform center point of the following mobile platform; and
a route-command generating unit, electrically connected with the platform-center positioning unit and the target-center judging unit, used for applying the target center point and the platform center point to generate the following command.

6. The following mobile platform of claim 5, wherein the following command generation module further includes a distance judging unit electrically connected with the target-center judging unit, the platform-center positioning unit and the route-command generating unit and used for applying the platform center point and the target center point to calculate a distance between the following mobile platform and the followed target, and the route-command generating unit is applied to generate the following command upon when the distance is greater than a preset distance.

7. The following mobile platform of claim 1, wherein the scanning module further includes a scanning-area adjusting unit for adjusting the scanning area.

8. A method for following a mobile object, applied to the following mobile platform of claim 1, comprising the steps of:
(a) applying the scanning module to scan and generate the first scan information and the second scan information;
(b) applying the judging module to determine the first scan information and the second scan information, and defining the user to be the followed target upon when the user facing or facing away from the following mobile platform is within the target-locked area;
(c) applying the following command generation module to generate the following command for following the followed target upon when the followed target moves within the scanning area; and
(d) applying the controlling module to evaluate the following command to generate the control signal for controlling the following mobile platform to move with the followed target according to the following command.

9. The method for following a mobile object of claim 8, wherein the scanning module further includes a calf-shape judging unit, and the step (b) further includes a step of (bl) applying the calf-shape judging unit to confirm that the user facing or facing away from the following mobile platform is within the target-locked area upon when the first scan information includes two quasi-semicircular arcs adjacent to each other and with the same shape and intensity.

10. The method for following a mobile object of claim 8, further including a step of (e) applying a time unit of the judging module to calculate a preset time, and relieving the user from the followed target upon when the judging module determines that the user is not within the scanning area for the preset time.
